(19) United States
(12) Patent Application Publication
(10) Pub. No.: US 2018/0329742 A1
(43) Pub. Date: Nov. 15, 2018

(54) TIMER-ASSISTED FRAME RUNNING TIME ESTIMATION

(71) Applicant: MediaTek Inc., Hsinchu (TW)

(72) Inventors: Tzu-Jen Lo, New Taipei (TW); Yu-Ming Lin, Taipei (TW); Te-Hsin Lin, New Taipei (TW); Shu-Mei Huang, Taipei (TW); Po-Ting Chen, Taipei (TW)

(21) Appl. No.: 15/974,002

(22) Filed: May 8, 2018

Related U.S. Application Data
(60) Provisional application No. 62/503,999, filed on May 10, 2017.

(51) Int. Cl. G06F 9/48; G06F 9/50

(52) U.S. Cl. CPC G06F 9/4887; G06F 9/5027

(57) ABSTRACT

Frame running time of a device is estimated dynamically. The device includes a processor that executes threads of an application, and a graphics processor that receives commands from the processor for rendering frames. For each frame, the processor records a timer period for each thread in a set of threads that contribute to operations of a render thread. The render thread writes the commands for the graphics processor to render the frames. Each thread in the set of threads has a corresponding timer that controls a sleep state of the thread. The processor calculates a frame non-running time for a current frame using recorded one or more timer periods, and calculates the frame running time for the current frame by subtracting the frame non-running time from an end-to-end frame period.

### CROSS-REFERENCE TO RELATED APPLICATIONS

This application claims the benefit of U.S. Provisional Application No. 62/503,999 filed on May 10, 2017.

### TECHNICAL FIELD

Embodiments of the invention relate to graphics systems and performance management of graphics systems.

### BACKGROUND

The advance in graphics systems enables rapid development of graphics-intensive applications, such as video games, virtual reality, artificial intelligence, and the like. To execute these applications, a graphics system consumes a significant amount of system resources and power. Analyzing when and how much a graphics application utilizes system resources and power can help allocating system resource, setting time budget and scheduling. One indicator of how much a graphics application utilizes allocated system resources is the frame running time, which, defined at a high level, is the time duration when the application is actively executing one or more tasks for rendering a frame.

To optimize a system's power efficiency, it is a goal of a system designer to allocate a time-constrained task the least amount of resources that the task needs to complete just in time. Identifying the frame running time can help the system designer to achieve this goal.

Typically, user experience (UX) applications stay running until the completion of a frame. Some other applications, such as game applications, may have intermittent wakeup and sleep periods. As game applications typically have many interdependent parallel threads executing and sleeping at different times, identifying the frame running time for such applications can be a difficult task.

Conventional methods for estimating the frame running time generally ignore the duration of sleep of these threads, thus over-estimating the frame running time. One of these threads is a render thread. Using the render thread's running time to represent the frame running time would under-estimate the frame running time.

### SUMMARY

In one embodiment, a device is provided for dynamically estimating frame running time. The device comprises a processor to execute a plurality of threads of an application, and a graphics processor to receive commands from the processor for rendering frames. For one or more of the frames, the processor is operative to: record a timer period for each thread in a set of threads contributing to operations of a render thread which writes the commands for the graphics processor to render the frames; calculate a frame non-running time for a current frame using recorded one or more timer periods; and calculate the frame running time for the current frame by subtracting the frame non-running time from an end-to-end frame period. Each thread in the set of threads has a corresponding timer that controls a sleep state of the thread.

In another embodiment, a method is provided for dynamically estimating frame running time. The method comprises: recording a timer period for each thread in a set of threads contributing to operations of a render thread which writes commands for a graphics processor to render frames; calculating a frame non-running time for a current frame using recorded one or more timer periods; and calculating the frame running time for the current frame by subtracting the frame non-running time from an end-to-end frame period. Each thread in the set of threads has a corresponding timer that controls a sleep state of the thread.

In yet another embodiment, a processor is operative to dynamically estimate frame running time. The processor comprises memory containing instructions that when executed cause the processor to perform operations of: recording a timer period for each thread in a set of threads contributing to operations of a render thread which writes commands for a graphics processor to render frames; calculating a frame non-running time for a current frame using recorded one or more timer periods; and calculating the frame running time for the current frame by subtracting the frame non-running time from an end-to-end frame period. Each thread in the set of threads has a corresponding timer that controls a sleep state of the thread.

Embodiments of the invention improve accuracy in the estimation of frame running time. A system may use the estimated frame running time to allocate system resource such that graphics execution and rendering tasks can be finished just in time within a time budget of a frame to thereby minimize system resource waste. Reduction in system source waste, in turn, reduces system power consumption.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

FIG. 1 is a block diagram illustrating an embodiment of a device in which embodiments of the invention may operate.

FIG. 2 illustrates an example of frame running time calculation according to one embodiment.

FIG. 3A illustrates another example of frame running time calculation according to one embodiment.

FIG. 3B illustrates yet another example of frame running time calculation according to one embodiment.

FIG. 4 is a flow diagram illustrating a method for determining a system resource to request according to one embodiment.

FIG. 5 is a flow diagram illustrating a method for dynamically estimating frame running time according to one embodiment.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description. It will be appreciated, however, by one skilled in the art, that the invention may be practiced without such specific details. Those of ordinary skill in the art, with the included descriptions, will be able to implement appropriate functionality without undue experimentation.

Embodiments of the invention provide a device, a method and a processor, which calculate frame running time based on timers associated with a set of threads of an application. Some or all of the threads may be time-constrained; that is, they must complete scheduled tasks before a deadline (or respective deadlines). The knowledge of execution behaviors in a frame improves allocation of system resource. A process may request an amount of system resource for executing the application based on, at least in part, the frame running time. An end-to-end frame period (or referred to as “frame period”) may include frame running time and frame non-running time. The frame non-running time can be calculated by the union of timer periods of a set of threads that contribute to the operations of the render thread in a frame. In the following description according to embodiments of the invention, the set of threads that contribute to the operations of the render thread may also include the render thread. The term “contributing thread” more specifically refers to a thread that wakes up the render thread, or a thread that is not the render thread but contributes to the operations of the render thread either directly or indirectly.

A processor, such as a central processing unit (CPU), may execute contributing threads as well as non-contributing threads and a render thread during a frame period. The render thread is executed by the CPU during each frame period to instruct a graphics processor, such as a graphics processing unit (GPU), to render graphics in a frame to be displayed on a display screen. Although CPU and GPU are described herein, it is understood that the CPU and the GPU may be replaced by other types of processors, where the former commands the latter to render graphics in frames (also referred to as “to render frames”).

A contributing thread may be associated with (i.e., corresponding to) zero, one or more timers. Generally, when a system executes graphics applications, timer(s) may be deployed to control the time at which a thread's running time start. The timer is set when the thread goes to sleep, and the system wakes up the thread when the timer ends. The timer start time and the timer end time are recorded in the system. The timer period, which is the time duration between the timer start time and the timer end time, can be used for calculating a frame non-running time. The end-to-end frame period minus the frame non-running time is the frame running time. In the following description, the terms “time” and “period” may be used interchangeably. For example, the term “running time” is equivalent to “execution period.” Furthermore, in the following description a contributing thread is described as having a corresponding timer. It is understood that the description can be extended to a contributing thread having more than one corresponding timer. A contributing thread having no corresponding timer is not taken into account when estimating the frame running time.

A thread's running time is the time duration when its corresponding timer does not run. During a contributing thread's running time, the contributing thread may be actively performing tasks in a number of time slices and may be stalled between the time slices. The stalls may be caused by resource sharing, waiting for results from other threads or software entities, waiting for a lower-layer software entity to complete a task, and the like. During the contributing thread's running time, the number of stalls may be so numerous that tracking the start and end times of each time slice can be impractical. The contributing thread's timer does not track the stalled time between the time slices in the running time, and the timer is observable by the operating system's framework (e.g. the application framework) that supports the execution of the application. Thus, using timer periods to estimate the frame running time incurs low overhead to the system. The estimated frame running time can be used by the system to determine the right amount of system resource to request, such that the allocated system resource can be fully utilized without waste while meeting the performance requirements such as the time budget for the frame period. For example, a system may determine a system resource to allocate to a graphic application or a gaming engine to render a next frame based on the frame running time estimated from the current frame (or the current frames and one or more prior frames). When the right amount of system resource is allocated, the next frame can be rendered just in time within the time budget deadline. Reducing the allocation of system resource can reduce system power consumption. The non-frame running time is an indication of under-utilization of system resources; the system resource is allocated with an aim to minimize the non-frame running time in the next frame or frames. The allocated system resource may include processing capacity, memory capacity, power allocation, time budget, etc.

According to embodiments of the invention, the frame running time may be calculated based on the knowledge of the threads' dependency relationship with the render thread, and the knowledge of each contributing thread's state change (e.g., when the contributing thread wakes up and sleeps). The application framework keeps track of this dependency relationship and the state change of each thread, and retains the history of frame running time and the history of system resource for determining the right amount of system resource to allocate in the next frames.

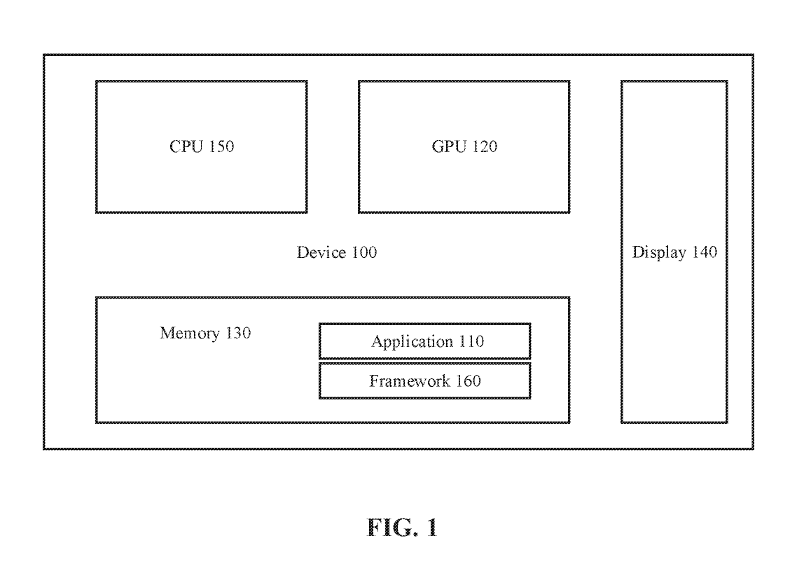

FIG. 1 is a block diagram illustrating an embodiment of a device 100 in which embodiments of the invention may operate. The device 100 includes at least a processor such as a central processing unit (CPU) 150, a graphics processor such as a graphics processing unit (GPU) 120, memory 130 and a display 140. The device 100 may also include a number of user interfaces and network interfaces (not shown). The device 100 may include multiple CPUs and GPUs, as well as other processing units. Additional details of the device 100 are omitted for simplicity of the description. The device 100 may be a graphics system, an entertainment system, a multimedia device, a gaming device, a communication device, a workstation, a desktop computer, a laptop computer, a mobile phone, or any device, system or node having the capability of rendering frames.

In one embodiment, the CPU 150 executes an application 110, which includes instructions for generating graphics content to be displayed on the display 140. In one embodiment, the CPU 150 sends commands to the GPU 120 to render frames in accordance with execution of the application 110. The commands may be queued in a command buffer. After the GPU 120 renders the frames, the content of each frame is sent to a frame buffer. A display controller reads the content from the frame buffer for display on the display 140.

The CPU 150 includes circuitry to perform logical and mathematical calculations. For the purpose of rendering frames for the application 110, the CPU 150 may generate commands for the GPU 120 to execute. The GPU 120 includes circuitry to perform the operations of graphics modeling and processing. For example, the GPU 120 may model a graphical object with primitives, manipulate the primitives by their vertices and pixels, generate surfaces containing rendered graphics, composite the surfaces, and write the composited surface to a frame buffer.

The GPU 120 generates new frames at a frame rate controlled by the CPU 150 according to a time budget. The frame rate may be a fixed frame rate or may vary from one frame to the next. The display 140 refreshes the displayed content at a refresh rate, which may be the same or different from the frame rate.

In one embodiment, the CPU 150 executes a render thread to generate commands for each frame of the application 110. In every frame, the render thread wakes up to write commands into the command buffer, and after finishing writing the commands for the frame, the render thread goes back to sleep. The time instant when the render thread enters the sleep state is the beginning of the next frame. The render thread may be wakened up by another thread (i.e., a contributing thread) when that thread has produced some output that triggers the wakeup of the render thread. In one embodiment, the render thread's running time is included in the frame running time.

In one embodiment, the device 100 executes an application framework 160 which provides a software infrastructure for the application 110 to interface with lower-layers of the operating system (e.g., drivers) and graphics execution. The application framework 160 supports the execution of the application 110 and other applications that runs on the device 100. In one embodiment, the application framework 160 estimates the frame running time for each frame of the application 110 execution, and requests an amount of system resource to be allocated for the execution of the application 110 based on the frame running time.

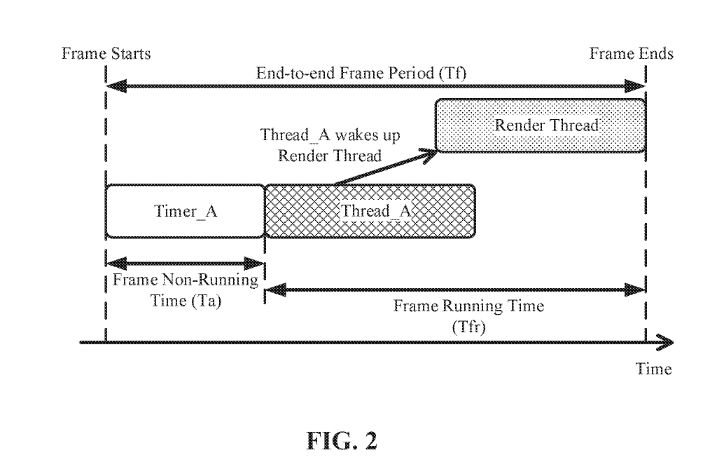

FIG. 2 illustrates an example of frame running time calculation according to one embodiment. A frame period is the time interval between a frame starts and the frame ends. A render thread is executed in each frame period. When the render thread completes writing commands into a command buffer for a GPU to execute, the completion of the command writes marks the end of the current frame and the start of the next frame. The render thread may be dependent on the results or output of other threads (e.g., Thread_A), which may be executed in the same frame time, in one or more previous frames or a combination of both. In this example, partially into its running time, Thread_A wakes up the render thread. Thread_A may continue to feed its output to the render thread during Thread_A's running time. Thread_A itself may also wake up periodically. In an example where the application 110 (FIG. 1) is a game application, Thread_A (or one or more other threads from which Thread_A depend) may be wakened up in response to a gamer's action. Thread_A has a corresponding Timer_A, which is “on” for the timer period of Ta. The timer period of Ta is the sleep time of Thread_A. In this simplified example, Ta is the frame non-running time, because Thread_A is the only contributing thread and the time period Ta does not overlap with the render thread's running time. The frame running time (Tfr) starts when Thread_A starts and ends when the render thread ends. In this example, the frame running time (Tfr) may be calculated by subtracting Ta from the end-to-end frame period (Tf); that is, Tfr=Tf−Ta.

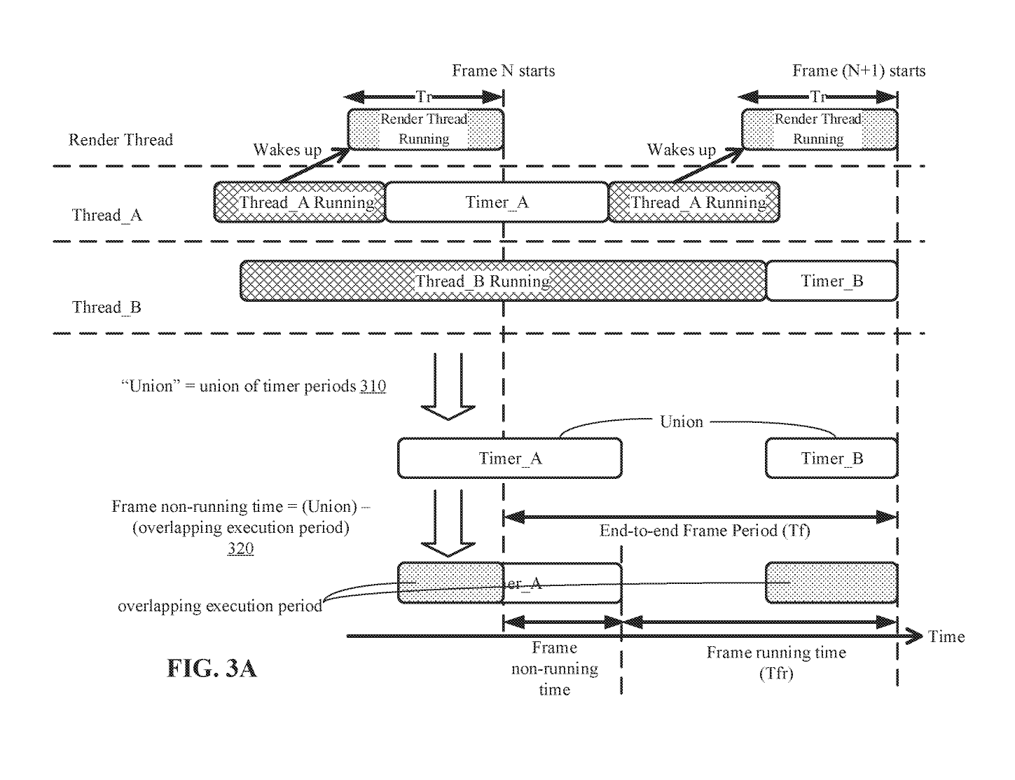

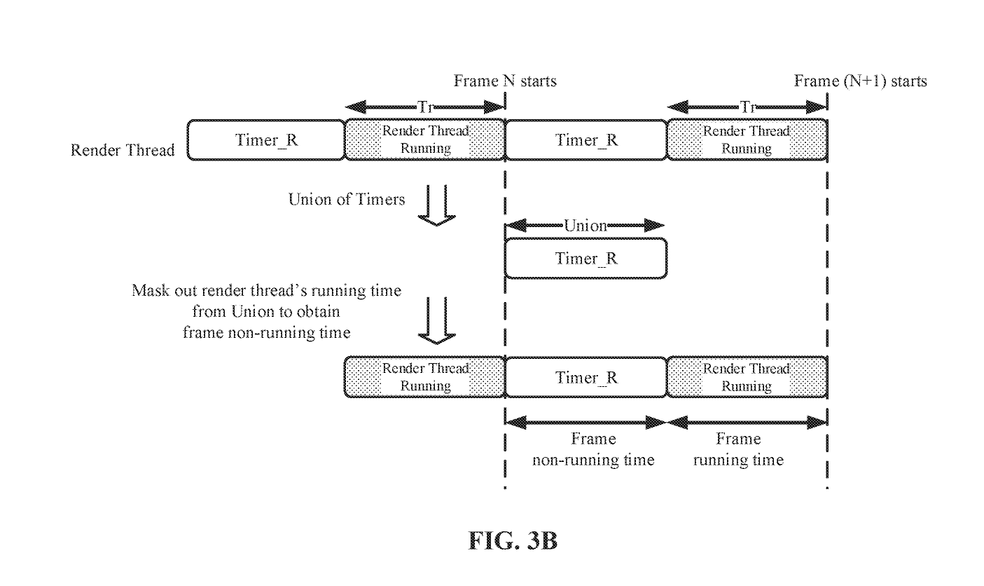

According to embodiments of the invention, the lower bound of the frame running time is the render thread's running time, and the upper bound is the end-to-end frame time. The difference between the end-to-end frame time and the frame running time is the frame non-running time, during which at least one contributing thread is in the sleep state. According to embodiments of the invention, the frame non-running time is calculated first using the union of timer periods, and the frame running time is calculated by subtracting the frame non-running time from the end-to-end frame period. An example where there are two contributing threads is provided in FIG. 3A.

FIG. 3A illustrates another example of frame running time calculation according to one embodiment. In this example, there are two contributing threads: Thread_A and Thread_B. Both Thread_A and Thread_B are executed in parallel with the render thread. Thread_A may be dependent on the tasks performed by Thread_B, and Thread_A is responsible for waking up the render thread. Thread_A has a corresponding Timer_A, and Thread_B has a corresponding Timer_B. At step 310, the union of all timers associated with the contributing threads is calculated as Union. Note that Union is obtained by taking into account each timer period's start time and end time, and may include one or more time periods. In this example, Union includes the two timer periods of Timer_A and Timer_B. In an alternative embodiment, Union may include only the timer periods within the current frame (e.g., frame N); that is, the tail-end portion of Timer_A (after frame N starts) and the entire Timer_B.

At step 320, the frame non-running time is calculated by removing the overlapping execution period from Union, where the overlapping execution period is the portion of Union that overlaps with the render thread's running time (Tr). Thus, during the frame non-running time, at least one contributing thread is in the sleep state. If any portion of the frame non-running time falls outside the current frame's end-to-end frame period, that portion is not counted as part of the frame non-running time. Finally, the frame running time (Tfr) for the current frame is the end-to-end frame period (Tf) minus the frame non-running time.

In one embodiment, when the dependency relationship between a given thread and the render thread is unknown, the given thread may be assumed to be a contributing thread to the render thread.

FIG. 3B illustrates yet another example of frame running time calculation according to one embodiment. In this example, there is no contributing thread; the frame includes only a render thread which wakes up when its timer (Timer_R) ends, and goes to sleep when the timer is set. Similar to the description in FIG. 3A, Union is obtained by taking into account each timer period's start time and end time. In this example, the union includes one timer period; i.e., the timer period of Timer_R. The frame non-running time is calculated by masking out (i.e., removing) the render thread's running time (Tr) from Union. As there is no overlap between the render thread's running time (Tr) and Union, the frame non-running time is equal to the time during of Union, which is equal to the Timer_R period. The frame running time (Tfr) for the current frame is the end-to-end frame period (Tf) minus the frame non-running time, which in this example is equal to the render thread's running time (Tr).

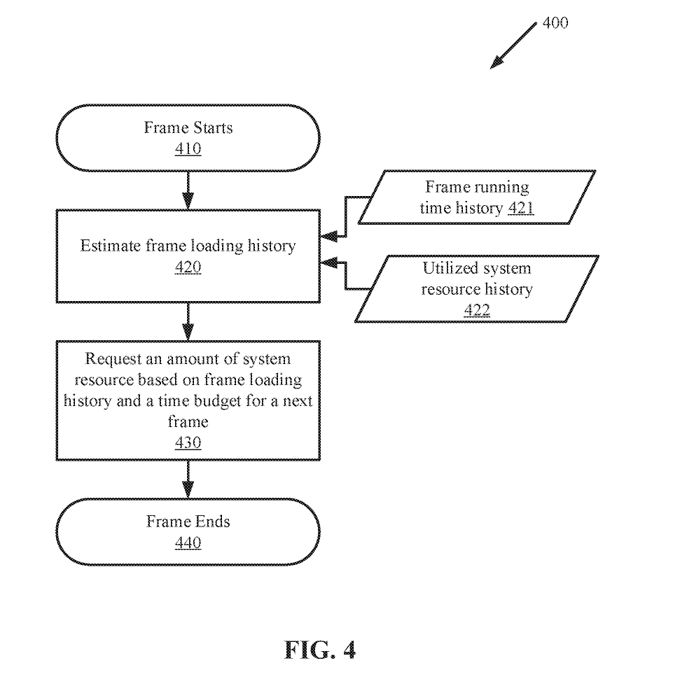

FIG. 4 is a flow diagram illustrating a method 400 for determining a requested system resource according to one embodiment. The method 400 may be performed by the device 100 of FIG. 1. In one embodiment, the method 400 may be performed by the application framework 160 of FIG. 1.

The method 400 begins at step 410 when a frame (i.e., a current frame) starts. The frame loading history is estimated at step 420, taking into account the frame loading of the current frame and past frames. The frame loading refers to the workload on the system (e.g., the CPU 150) incurred by a frame. In one embodiment, the frame loading may be calculated by multiplying the frame running time and the system resource utilized by a frame. In one embodiment, the estimation of the frame loading history may include a history of frame running time 421 (i.e., the frame running time of the current and past frames) and a history of utilized system resource 422 (i.e., the system resource utilized by the current and past frames). According to the estimated frame loading history and the time budget for generating a next frame (or next frames), an amount of system resource is requested for the next frame or frames. For example, the requested amount of system resource may be equal to the average frame loading divided by the time budget for the next frame, where the average frame loading is calculated from the frame loading history of the current and N past frames (N is a positive integer). The calculation of requested system resource allows full utilization of allocated system resources while satisfying the time budget for on-time frame generation.

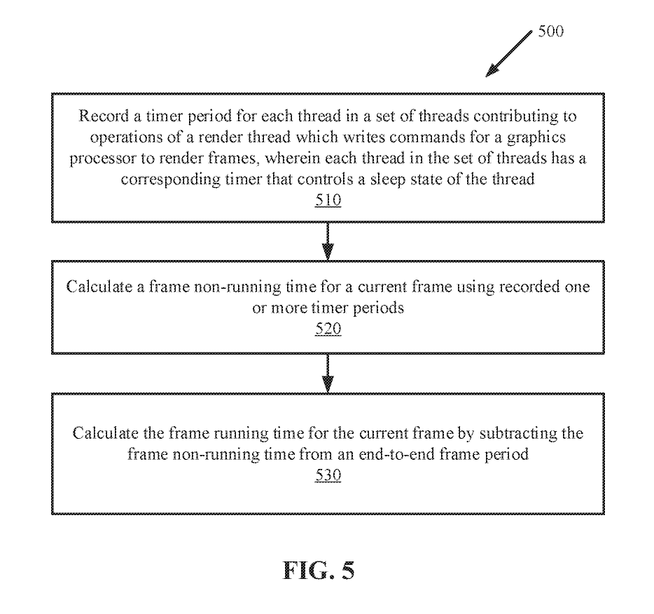

FIG. 5 is a flow diagram illustrating a method 500 for estimation of frame running time according to one embodiment. The method 500 may be performed by the device 100 of FIG. 1. In one embodiment, the method 500 may be performed by the application framework 160 of FIG. 1.

The method 500 begins at step 510 with the application framework 160 recording a timer period for each thread in a set of threads contributing to operations of a render thread, where the render thread writes commands for a graphics processor to render frames. Each thread in the set of threads has a corresponding timer that controls a sleep state of the thread. At step 520, a frame non-running time is calculated for a current frame using recorded one or more timer periods. At step 530, the frame running time is calculated for the current frame by subtracting the frame non-running time from an end-to-end frame period.

It is noted that operations performed by the application framework 160 are executed by the CPU 150 according to instructions contained in the application framework 160. The instructions may be stored in a machine-readable medium (such as a non-transitory machine readable storage medium). The non-transitory machine-readable medium may be any suitable tangible medium including a magnetic, optical, or electrical storage medium, which include volatile or non-volatile storage mechanisms. The machine-readable medium may contain various sets of instructions, code sequences, configuration information, or other data, which, when executed, cause a processor to perform steps in a method according to an embodiment.

The operations of the flow diagrams of FIGS. 4 and 5 have been described with reference to the exemplary embodiment of FIG. 1. However, it should be understood that the operations of the flow diagrams of FIGS. 4 and 5 can be performed by embodiments of the invention other than the embodiment of FIG. 1, and the embodiment of FIG. 1 can perform operations different than those discussed with reference to the flow diagrams. While the flow diagrams of FIGS. 4 and 5 show a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, and can be practiced with modification and alteration within the spirit and scope of the appended claims. The description is thus to be regarded as illustrative instead of limiting.

What is claimed is:

1. A device operative to dynamically estimate frame running time, comprising:
a processor to execute a plurality of threads of an application; and
a graphics processor to receive commands from the processor for rendering frames,
wherein, for one or more of the frames, the processor is further operative to:
record a timer period for each thread in a set of threads contributing to operations of a render thread which writes the commands for the graphics processor to render the frames, wherein each thread in the set of threads has a corresponding timer that controls a sleep state of the thread;
calculate a frame non-running time for a current frame using recorded one or more timer periods; and
calculate the frame running time for the current frame by subtracting the frame non-running time from an end-to-end frame period.

2. The device of claim 1, wherein in a given frame of the frames the set of threads include at least one thread that causes the render thread to wake up.

3. The device of claim 1, wherein in a given frame of the frames the set of threads include the render thread only.

4. The device of claim 1, wherein when calculating the frame non-running time, the processor is further operative to:
calculate a union of the recorded one or more timer periods for the current frame.

5. The device of claim 4, wherein the processor is further operative to:
remove an overlapping execution period of the render thread from the union to obtain the frame non-running time for the current frame, wherein the overlapping execution period of the render thread is a portion of the execution period that overlaps with the union.

6. The device of claim 4, wherein the union has a start time equal to an earliest start time among the one or more timer periods, and an end time equal to a latest end time among the one or more timer periods.

7. The device of claim 1, wherein the processor is further operative to:
request an amount of system resource based on the frame running time for a next frame.

8. The device of claim 7, wherein, when request the system resource, the processor is further operative to:
estimate a frame loading history based on a history of the frame running time and a history of utilized system resource, wherein the frame loading history incorporates the frame running time and the utilized system resource of the current frame; and
determine the amount of system resource to request based on the frame loading history and a time budget for the next frame.

9. The device of claim 7, wherein the processor is further operative to:
multiply the frame running time by the utilized system resource to obtain a frame loading; and
divide an average of the frame loading by the time budget to obtain the amount of system resource to request.

10. A method for dynamically estimating frame running time, comprising:
recording a timer period for each thread in a set of threads contributing to operations of a render thread which writes commands for a graphics processor to render frames, wherein each thread in the set of threads has a corresponding timer that controls a sleep state of the thread;
calculating a frame non-running time for a current frame using recorded one or more timer periods; and
calculating the frame running time for the current frame by subtracting the frame non-running time from an end-to-end frame period.

11. The method of claim 10, wherein in a given frame of the frames the set of threads include at least one thread that causes the render thread to wake up.

12. The method of claim 10, wherein in a given frame of the frames the set of threads include the render thread only.

13. The method of claim 10, wherein calculating the frame non-running time further comprises:
calculating a union of the recorded one or more timer periods for the current frame.

14. The method of claim 13, wherein calculating the frame non-running time further comprises:
removing an overlapping execution period of the render thread from the union to obtain the frame non-running time for the current frame, wherein the overlapping execution period of the render thread is a portion of the execution period that overlaps with the union.

15. The method of claim 13, wherein the union has a start time equal to an earliest start time among the one or more timer periods, and an end time equal to a latest end time among the one or more timer periods.

16. The method of claim 10, wherein after calculating the frame running time, the method further comprises:
requesting an amount of system resource based on the frame running time.

17. The method of claim 16, wherein requesting the system resource further comprises:
estimating a frame loading history based on a history of the frame running time and a history of utilized system resource, wherein the frame loading history incorporates the frame running time and the utilized system resource of the current frame; and
determining an amount of system resource to request based on the frame loading history and a time budget for a next frame.

18. The method of claim 16, wherein requesting the amount of system resource further comprises:
multiplying the frame running time by the utilized system resource to obtain a frame loading; and
dividing an average of the frame loading by the time budget to obtain the amount of system resource to request.

19. A processor operative to dynamically estimate frame running time, comprising memory containing instructions that when executed cause the processor to perform operations of:
recording a timer period for each thread in a set of threads contributing to operations of a render thread which writes commands for a graphics processor to render frames, wherein each thread in the set of threads has a corresponding timer that controls a sleep state of the thread;
calculating a frame non-running time for a current frame using recorded one or more timer periods; and
calculating the frame running time for the current frame by subtracting the frame non-running time from an end-to-end frame period.

20. The processor of claim 19, wherein the memory further contains instructions that when executed cause the processor to perform the operations of:
calculating a union of the recorded one or more timer periods for the current frame; and
removing an overlapping execution period of the render thread from the union to obtain the frame non-running time for the current frame, wherein the overlapping execution period of the render thread is a portion of the execution period that overlaps with the union.
